(19) United States
(12) Patent Application Publication
(10) Pub. No.: US 2008/0301394 A1
(43) Pub. Date: Dec. 4, 2008

(54) Method And A System To Determine Device Criticality During SAN Reconfigurations

(76) Inventors: Kishore Kumar MUPPIRALA, Bangalore (IN); Narayanan Ananthakrishnan Nellayi, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/125,941

(22) Filed: May 23, 2008

(30) Foreign Application Priority Data
May 29, 2007 (IN) 1115/CHE/2007

(51) Int. Cl. G06F 12/06

(52) U.S. Cl. 711/170; 711/E12.084

(57) ABSTRACT

A method, a system and a computer program for determining device criticality during SAN reconfiguration operations comprising the steps of building the SAN connectivity graph and mapping the reconfiguration on SAN connectivity graph; locating the affected host systems; and determining the device criticality for each of the affected host systems. The hosts systems may also be provided with impact analysis agents to generate device criticality on host systems and a central agent to aggregate the device criticality from impact analysis agent and provide feedback to data center administrator.

### RELATED APPLICATIONS

Benefit is claimed under 35 U.S.C. 119(a)-(d) to Foreign application Ser. 1115/CHE/2007 entitled “A METHOD AND A SYSTEM TO DETERMINE DEVICE CRITICALITY DURING SAN RECONFIGURATIONS” by Hewlett-Packard Development Company, L.P., filed on 29 May, 2007, which is herein incorporated in its entirety by reference for all purposes

### BACKGROUND OF THE INVENTION

A data center is a facility used for housing a large amount of electronic equipment, typically computers and communication equipments. Typical components of a data center may include Servers; Storage Devices; Storage Area Network Components, like inter-connection cables, switches, hubs; and Data network elements, like LAN cables and switches/hubs. A storage area network (SAN) is a network designed to attach computer storage devices to servers. A SAN allows a machine to connect to remote targets such as disks and tape drives on a network for block level I/O.

In storage area networks the storage elements do not belong to individual servers. Instead, the storage elements are directly attached to the network and storage is allocated to the servers when required. The storage elements may be located remotely of the server systems. Therefore, even if the infrastructure containing the server systems is destroyed, the data may still be recovered. Moreover, the relocation of the host systems in the network is made easier because the storage elements need not be moved with the host systems. Additionally, the upgrade of the network may be easier because the hosts do not have to be upgraded individually in their separate locations. Yet further, if one server malfunctions the downtime of the system is reduced because a new server can quickly be set up and pointed at the relevant storage volumes in the storage elements without the need of recovering the data.

A network of data links including a plurality of switches is used to connect the servers and the storage elements in a SAN. To further reduce the downtime of the network as a result of a failure of one or more of the components, redundant links are often included between the servers and the storage elements such that if one link malfunctions another one can be used and the network can be used without interruptions. To manage the system and ensure that there are enough redundant paths, a management program is often used. The downtime of the system can further be reduced if the management program may analyse faults, assess the state of the network and ensure that the input/output continuity is maintained with optimal performance.

It is not uncommon for an administrator to perform maintenance and/or reconfiguration operations on the components that make up a data center. IT consolidation, hardware and software upgrades are some of the common reasons for such operations.

In a storage area network, before performing the maintenance operations the administrator will be interested in assessing the potential system and/or application level impacts in terms of availability and performance. The impact analysis of maintenance operation forms a core part of Application Management systems. Hence before planning and executing such maintenance operations, the administrator may be interested in knowing the answers for questions such as—“What would be impacted if I remove/replace this cable?”, “What would happen to systems/applications if I temporarily take this storage device offline for maintenance work?”, “Which applications are affected in my data center if a disk array controller or a disk in a enclosure is replaced/affected?”.

### BRIEF DESCRIPTION OF THE DRAWINGS

Embodiments of the invention will now be described by way of example only, with reference to accompanying drawings, wherein:

FIG. 1 is a schematic diagram of a SAN configuration.

FIG. 2 is a flow chart illustrating the steps involved in building a SAN graph.

FIG. 3 illustrates steps involved in a method for determining the device criticality for a SAN reconfiguration operation.

FIG. 4 illustrates steps involved in determining the device criticality at host level in a SAN configuration.

FIG. 5 illustrates a process of determining the logical and physical paths in the network.

FIG. 6 illustrates an example of a flow chart for traversal of component hierarchy graph for performing device criticality analysis on host of a system.

FIG. 7 illustrates an example of a component hierarchy graph of a host bus adapter in a SAN configuration.

### DETAIL DESCRIPTION OF THE EMBODIMENTS

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

There will be described a technique to determine the criticality or side-effects of a SAN reconfiguration operation in a data center by using Critical Resource Analysis (CRA) functionality and mapping the data center events to the host system level events. The technique employs an Impact Analysis Agent (IAA) to be deployed on each host of the data center. A central agent provided at a data center administrator node may aggregate the results from each of the Impact Analysis Agents across the data center and provide a consolidated report to the data center administrator. The central agent may consist of a SAN generation unit. The technique will now be described in more detail with reference to the enclosed drawings.

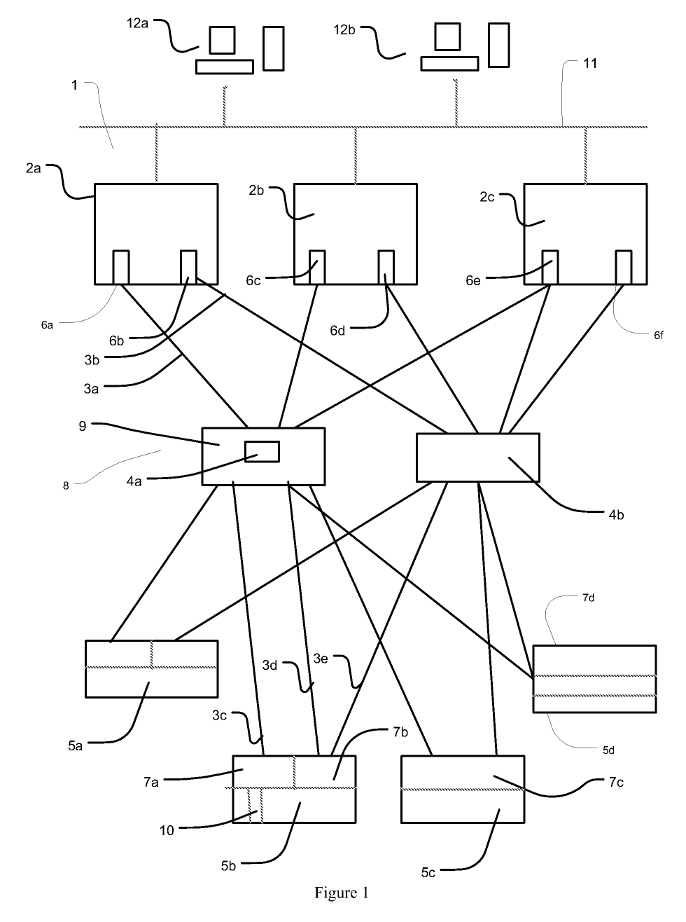

With reference to FIG. 1, a network 1 comprises a plurality of hosts 2a, 2b, 2c, connected to a plurality of data links 3a, 3b, 3c, 3d, 3e, a plurality of switches 4a, 4b and a plurality of storage elements 5a, 5b, 5c and 5d. The hosts may include but are not limited to servers 2a, 2b, 2c and client computers. The data links may include but are not limited to Ethernet interfaces connections, Fibre Channels and SCSI (Small computer System Interface) interfaces, for instance. The storage elements comprise disk drives and/or disk arrays 5a, 5b, 5c and tape drive arrays 5d.

Each host is connected to each storage element by at least two paths such that if a component or a data link in one path fails, data may still be exchanged between the host and the storage element using another path. Each server 2a, 2b, 2c therefore has at least one host bus adapter (HBA) 6a-6f for connecting to the switches through data links 3a, 3b. Similarly, each storage element 5b or cluster of storage elements has at least one controller 7a-7d for connecting to the data links 3c, 3d, 3e. The role of the HBAs 6a-6f is to provide the interface between the host and the attached data link. They may further provide input/output processing to offload most of the host processing required for transferring data. The controllers 7a-7d perform a similar role for the storage elements. Like the switches, the HBAs and the controllers may also have more than one port to provide alternative paths. In FIG. 1, port 6e is shown to have two ports. The network of HBAs 6a-6f, data-links 3a-3e, switches 4a, 4b and controllers 7a-7d that connect the hosts and the storage elements make up what is known as the fabric 8.

Each component of the SAN has a number of subcomponents 9, any one of which may affect the performance of the system. For example, each switch may have one or more ports, fans and/or power supplies.

Each host system 2a, 2b, 2c, is allocated a storage area which may be accessed through the fabric channels 8. The storage area may be distributed over different storage elements. The storage area may further be typically classified into a number of Logical Unit Numbers (LUNs) 10, each of which corresponds to an actual or virtual portion of a storage element. For example, a LUN 10 may correspond to one or more disks in a disk drive array.

The servers may be connected in a local area network (LAN) 11 to a number of client computers 12a, 12b. The client computers may be directly connected to the SAN with their own data links, such as fibre channels, or indirectly connected via the LAN and the servers.

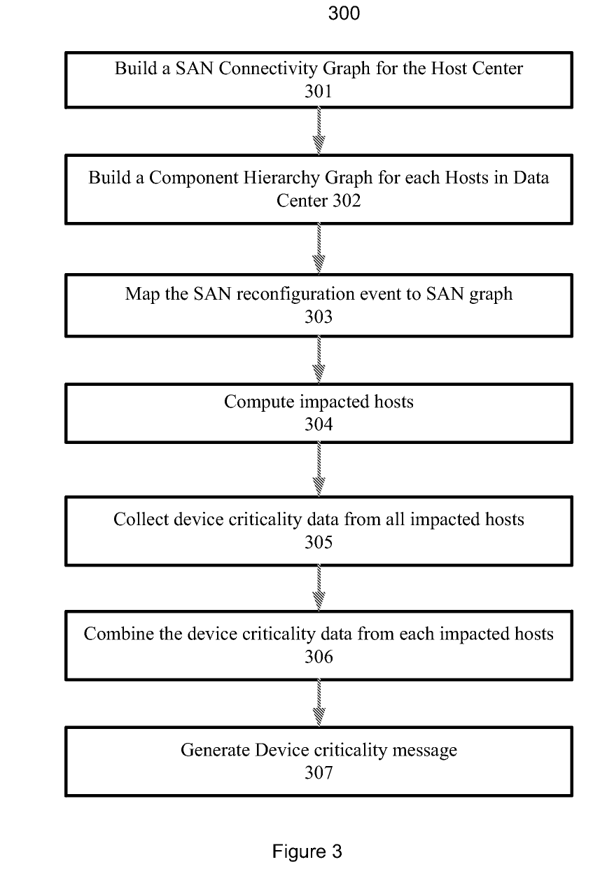

FIG. 3 illustrates the steps involved in determining the device criticality during SAN reconfiguration on a data center. In an embodiment, the present technique may be implemented as computer-executable instructions for performing the method 300 for determining device criticality for hot plugging in a SAN reconfiguration operation. The computer-executable instructions can be stored in any type of computer-readable medium, such as a magnetic disk, CD-ROM, an optical medium, a floppy disk, a flexible disk, a hard disk, a magnetic tape, a RAM, a ROM, a PROM, an EPROM, a flash-EPROM, or any other medium from which a computer can read.

In order to determine the impact on the SAN of an event related to the state of one or more components, the connections in the SAN must be identified and analysed. If a component is part of a path between a host 2 and a LUN 10 and the path is the only available path between the two components, the removal of the path will be critical to the performance of the system. However, if the path is just one of a large number of paths from host system to LUN 10 through the SAN 9, the fault has only a minor effect. Any alternative paths are referred to hereinafter as redundant paths.

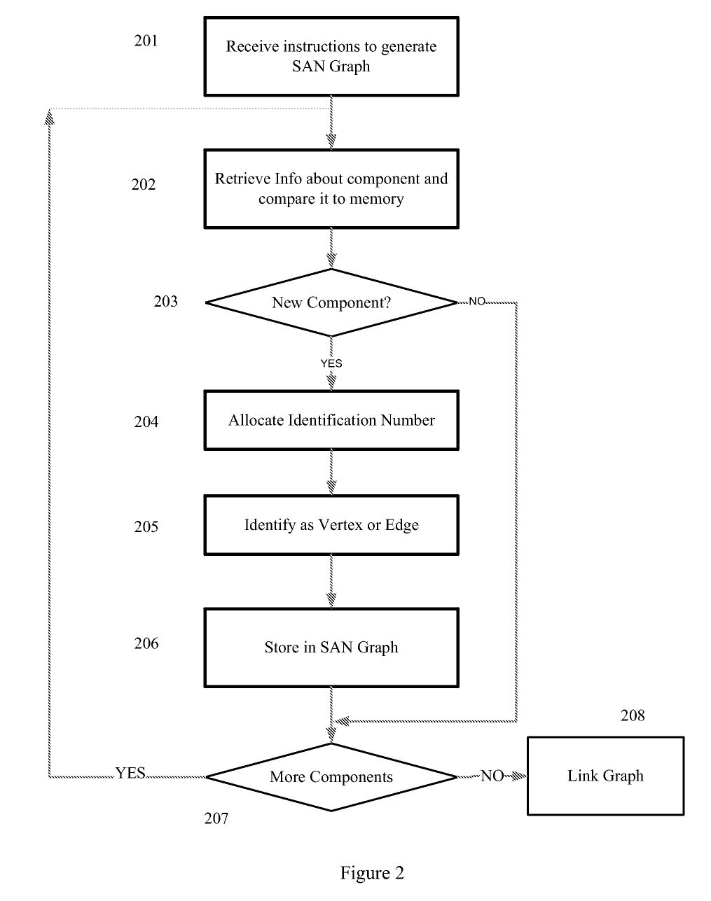

At step 301 of FIG. 3, the algorithm gathers information of the data center to build a SAN connectivity graph (referred to as “SAN Graph” from hereafter in the description). The edge nodes of the graph may be the LUNs exported by the disk arrays and the host bus adapters (HBA) ports of the hosts systems and/or server systems. Disk arrays, enclosures and controllers may be used to logically group the nodes of SAN graph so that any operation that impacts these components may be used to mark all the nodes of the logical group as “impacted”. The SAN infrastructure components like the switches, hubs, cables etc., may be mapped as the intermediate nodes and edges in the SAN graph. An algorithm for building SAN graph, as an example, is briefly described with respect to FIG. 2.

At step 201, the SAN graph generation unit receives instructions to generate a SAN graph. This is received when the user desires to reconfigure the SAN. In some embodiments, instructions to the SAN graph generation unit to regenerate the SAN graph may be communicated with a predetermined frequency, which is configurable by the user.

The SAN connectivity generation unit retrieves, at step 202, the information about the first component of the SAN from which information has been collected since the last time a SAN graph was generated. The information received for the component may comprise vendor and model data, an identification number, for example a World Wide Name (WWN), and connectivity information allowing the SAN graph generation unit to determine the neighbours of the component. The SAN connectivity generation unit also may check whether information about the component already exists in the SAN graph database, i.e. whether the collected data concerns a known component or if a new component has been added to the network. In case of the component being a new component, the SAN connectivity generation unit at step 204, assigns a unique identification number to the component. After assigning the identification number the component may be classified as edge or the vertex.

The components of the network may be split into two sets, vertices and edges. The set of vertices may include of the set of HBAs, the set of switches, the set of storage array controllers and the set of Logical Unit Numbers. The set of edges is the set of data-links that connect the vertices, for example fiber channel cables. Two vertices can be connected by one or more edges. After the identification the component is stored in SAN database 206.

After gathering the relevant information about a component, the SAN connectivity generation unit may check at step 207 whether the data collected contain information about further components. If there is no information about additional components, the process ends at step 208. If the collected data contain information about further components, the process repeats from step 202.

When information about all components has been added, the graph is linked at step 208. Linking the graph involves checking all the connections, determining all paths between a source component and a destination component and organising the data to be presented in a suitable way in the GUI to the administrator of the system.

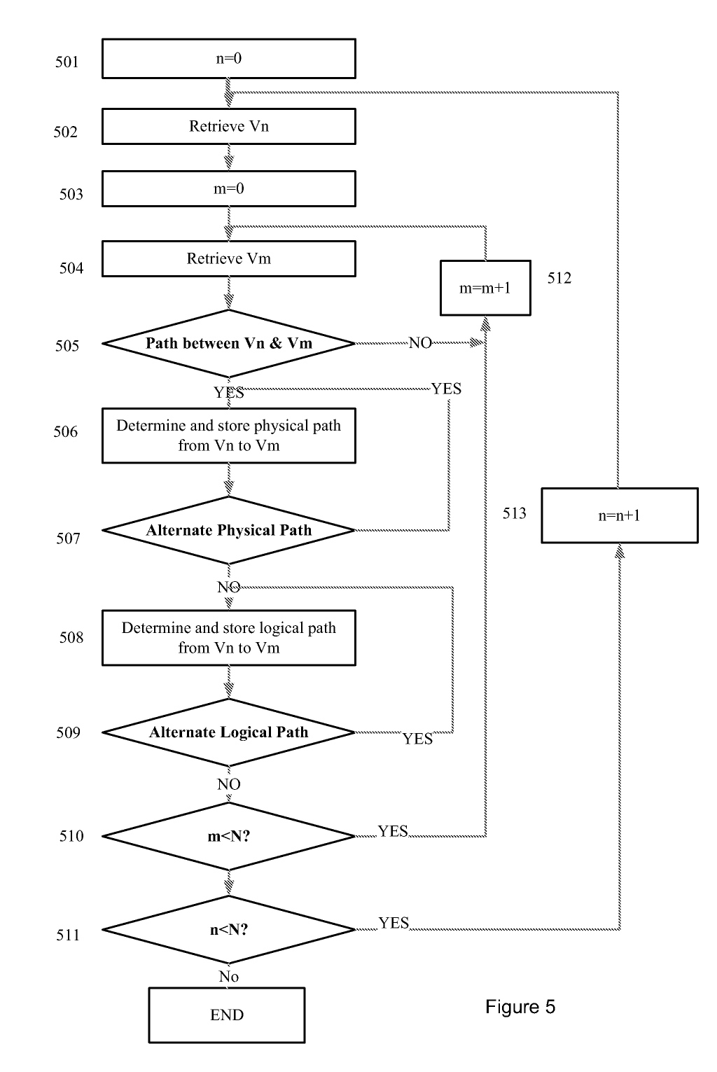

The process of determining all paths between a source component and a destination component will now be described in more detail with respect to FIG. 5. At step 501, the dummy variable n is set to 0. Subsequently, the record for the vertex with identification number vₙ, in this case v₀, is retrieved at step 502 from the SAN graph in SAN graph database 30. Dummy variable m also set to 0 at step 503 and the record for vₘ is retrieved at step 504.

At step 505 it is determined if there are any valid access paths between vₙ and vₘ. The edges in the SAN graph are directional from a host to a LUN. An access path may only be established in the direction from a host to a LUN. Therefore, for example, the paths between server 2a and 2c are not established, because that involves an edge going in the wrong direction. This step insures that only paths of interest are established and that paths between two vertices are only established once. For vₙ equal to v₀ and vₘ also equal to v₀, it is established at step 505 that there are no available valid paths, m is therefore increased by 1 at step 506 and it is then established at step 505 whether there are any valid paths between v₀ and v₁. When v₀ corresponds to server 2a and v₁ corresponds to LUN 10, it is determined at step 505 that there are valid paths and the process continues to step 507.

Both the physical paths and the logical paths are established for the pair of vertices vₙ and vₘ. A physical path is the sequence of vertices between the pair of components. A logical path is the sequence of edges.

A physical path is established between vertex v₀ and vertex v₁ at step 506 and identification numbers of the vertices in that path are stored in a high availability (HA) map in the SAN graph database. For server 2a and LUN 10, the path includes HBA 6a, switch 4a and controller 7a.

At step 507 it is checked whether there are alternative physical paths between host v₀ and LUN v₁. If it is established that there are alternative paths, step 506 is repeated and it is determined that an alternative path of HBA 6a, switch 4a and controller 7b exists. Steps 506 and 507 are repeated until all valid paths are found between the pair of nodes. The third and last path of HBA 6b, switch 4b and controller 7b is therefore also found. All of the paths are stored in the physical high availability (HA) map, HAₚ (v₀, v₁), in the SAN graph database with their respective sequences of vertices.

When there are no more alternative physical paths, the process continues to step 508 and a logical path between the two vertices is established. In the example discussed above, one logical path between host 2a and LUN 10 includes edges 3a and 3c. At step 509 it is determined whether there are alternative logical paths and, if there are, step 508 is repeated. In the example above, two additional paths, consisting of edges 3a and 3d and edges 3b and 3e respectively are found. All paths are then stored in a logical HA Map HA_{L} (v₀, v₁) in the SAN graph database with their respective sequences of edges.

When all the logical paths have been stored it is determined at step 509 that there are no more paths between v₀ and v₁, the process continues to step 510 and it is checked whether there is a vertex with a higher identification number than m. If there are, m is increased by 1 at step 512 and steps 504 to 509 are repeated for all paths between v₀ and v₂. When the valid paths between vertex v₀ and all other vertices have been established, it is determined at step 510 that there are no more vertices and the process proceeds to step 511. If there are, n is increased by 1 and steps 502 to 511 are repeated. The steps are repeated until the valid paths between all pairs of vertices in the system have been established and stored as physical and logical HA Maps.

Each host system node in the SAN graph may maintain a number of LUN nodes reachable, which is also referred to as the “reachable LUN set” in this description.

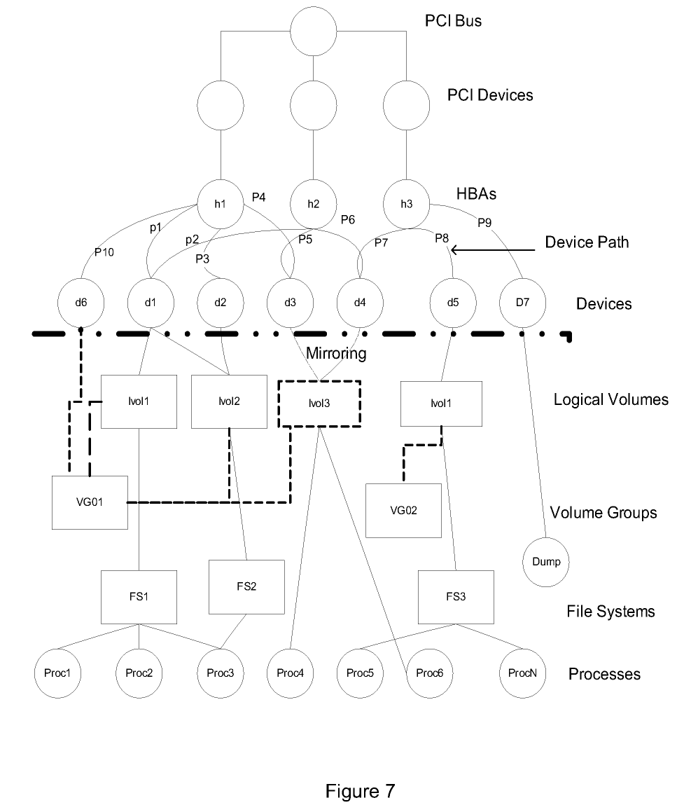

According to an embodiment, a component hierarchy graph (CHG) may be built for each host system of the data center, at step 302 of FIG. 3. The CHG is a graph mapping the elements of hardware as well as software from PCI bus onwards, down to the processes currently running on the host system. The process nodes are at the leaf or last level in CHG. The nodes at different levels of CHG may comprise of PCI slots, HBAs, HBA ports, LUN paths (also referred as edges from HBA port to LUNs), LUNs, Logical Volumes, Volume Groups, File Systems and processes. The edges in the CHG may indicate that the successor node is using and/or is dependent on the predecessor node. Thus, if a predecessor node is impacted and/or unavailable, the successor may also be unavailable, unless redundancy or alternative paths are available. A typical component hierarchy graph of a host system is depicted in FIG. 7 as an example. The component hierarchy graph for host system may be represented in the form of a directed acyclic graph (DAG).

The component hierarchy graph may include at each node certain attributes associated with each of the components of the computer system. These attributes may be a redundancy attribute, a criticality attribute or a usage attributes, for instance. The redundancy attribute may consist of number of redundant paths for the particular node.

The SAN graph and the component hierarchy graph of the host systems in a SAN can be prepared and stored at the boot time. Since the configuration of the SAN and/or host system does not change frequently, this may reduce the time in resource analysis. The changes in configurations of SAN may be reflected in the SAN graph and/or CHG. The SAN graph and CHG may be stored with central agent.

During the SAN reconfiguration operation, user indicates a desire to perform an online hot plug operation for example, adding, replacing, or removing a device(s) of a SAN in the data center. Here, it is assumed that the user knows which device(s) will be involved in the attempted reconfiguration operation.

Continuing at step 303 of FIG. 3, the SAN reconfiguration event is mapped to deletion and/or addition of edges and/or nodes into the SAN graph. The link removal and port removal events in the SAN reconfiguration may be mapped to edge removals in the SAN graph and addition/removal of controllers. Similarly the removal of switches and disk device enclosures may be mapped to node addition/removal operations. The SAN reconfiguration operation in a data center perspective, may involve one or more of the components of the SAN from the group of the link from the server system to the switch, the SAN switch(es), the link from the switch to the disk device, the device port/controller unavailability, the host system port (through a Host Hot-Plug operation).

According to an embodiment, the SAN reconfigurations operations in data center may be mapped to a host level impact in the following way. An impact on the link from the server system or the host system to the switch may be mapped to a hot-plug of the HBA for the host system. An impact on the disk device port, the corresponding “LUN paths” on the hosts system that use the LUNs exported by the device and/or disk-array are considered impacted. If the link from a switch to a device port is affected, it may be considered to be equivalent to a device port impact and the host systems using that LUNs under the device port to which the link is connected would be considered impacted. If a switch is affected, each link associated with that switch may be affected and may be mapped in the SAN graph in form of impact on host systems and device systems. The impact of a switch on other switches in the SAN through inter-switch-links (ISLs), and indirectly on other hosts systems and devices connected to the SAN is a well known graph theory problem of reachability of nodes and techniques exist to determine if an edge node loses path to another edge node (host/device) owing to loss of a node/edge (switch/ISL) in the graph. Thus, we can map the switch impacts to LUN path level impacts on the hosts connected to the SAN.

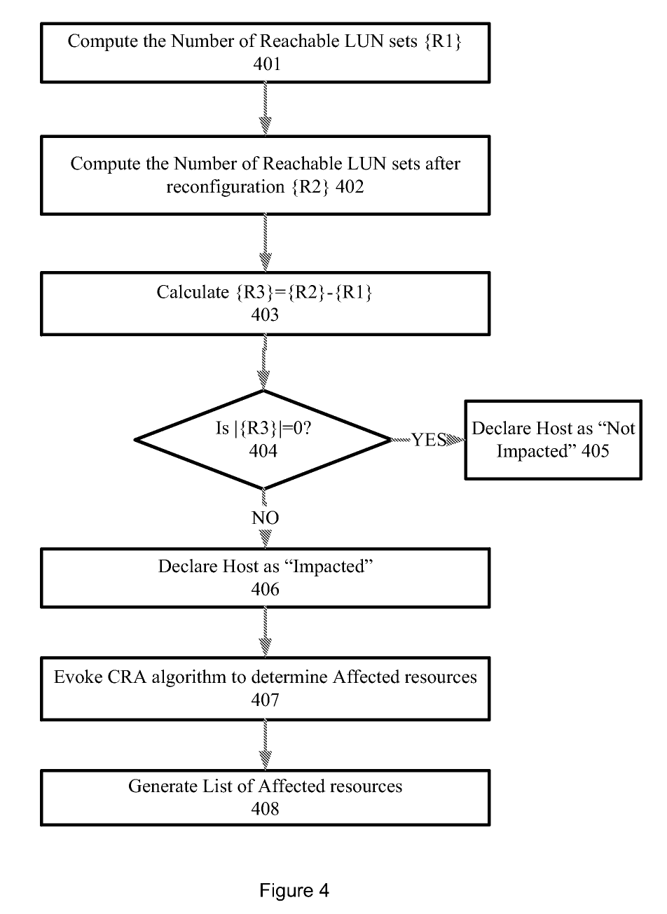

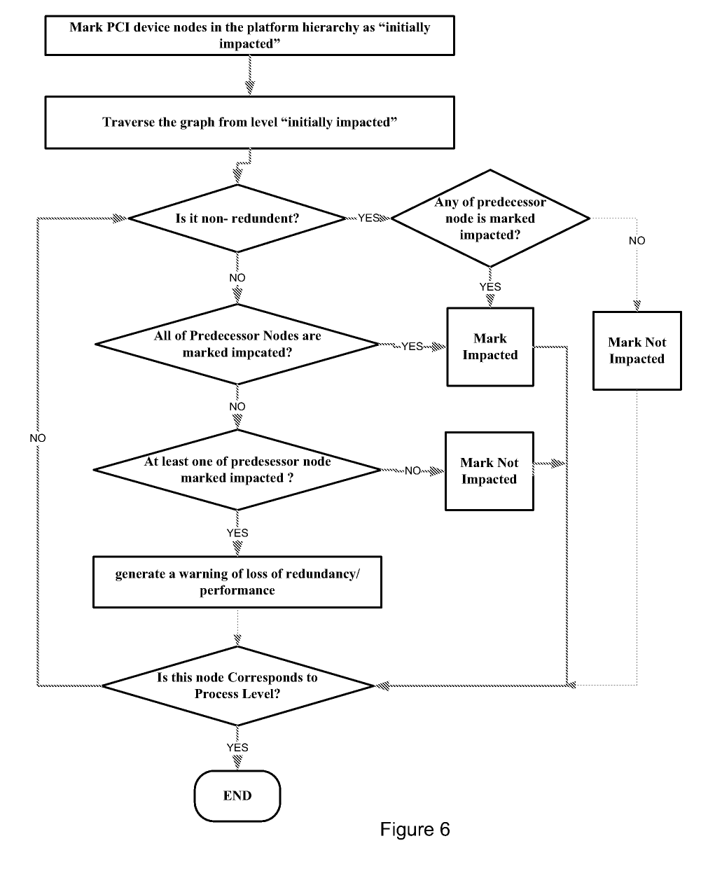

Continuing to step 304 of FIG. 3, the impacted hosts in the data center are identified. The algorithm for identifying the impacted hosts of the data center is illustrated in FIG. 4. The IAA invokes the device criticality analysis algorithm on the host system if the host system is determined to be impacted. An example of the algorithm for determining device criticality on a host system is illustrated in FIG. 6.

Further continuing to step 305 the device criticality data is accumulated from all the affected host systems across the data center. A central agent will aggregate the results received from the IAA across all the host systems and may provide a consolidated report to the data center administrator. The data center administrator may refer to the consolidated report for SAN reconfiguration operations.

FIG. 4 illustrates the algorithm for determining the impacted hosts in a data center of the step 304 of FIG. 3 in detail.

At step 401 the set of reachable LUNs for each of the host systems in the data center is computed before the SAN reconfiguration operation. The set of reachable node before SAN reconfiguration operation is also referred to as {R1} in this description. The set of reachable LUNs for a host system may be obtained by algorithm described in FIG. 4. This data is stored with local IAA agent at the host system node. At step 402 the IAA computes the set of reachable LUNs for a host system (also referred as {R2} in this description) after mapping the SAN reconfiguration operation in the SAN graph. The set of reachable LUNs {R2} for a host system may be different from {R1} after the SAN reconfiguration operation because of loss of an edge and/or access path.

Continuing to step 403 of FIG. 4, the set of LUNs lost by the host system is computed. The set of LUNs lost by a host system may be obtained by computing the difference between the set of reachable LUNs for a host system before mapping of SAN reconfiguration operation in the SAN graph {R1} from the set of LUNs reachable for a host system after the mapping of the SAN reconfiguration operation {R2}. The number of lost LUNs for a host system is also represented by {R3}; (|{R3}|=|{R1}−{R2}|) in this description. Further continuing to Step 404, if the set of LUNs lost {R3} by the host system is empty then the host system may be declared as “not impacted” 405. Since the set of reachable LUNs for a host system is same before and after i.e. {R1}={R2}, the mapping of SAN reconfiguration operation in the SAN graph, the particular host system is not impacted by the SAN reconfiguration operation.

If the set of LUNs lost {R3} by the host system is not empty then the particular host system is marked as “impacted” 406. Since the set of reachable LUNs for host system is not the same before and after the mapping of SAN reconfiguration operation in the SAN graph, the particular host system is impacted by the SAN reconfiguration operation. The impact may be because of the host system losing its LUN(s) after removal of edges and/or nodes from the SAN graph during the mapping of the SAN reconfiguration operation.

At step 407, if a host system is marked as “impacted”, the critical resource analysis (CRA) algorithm is evoked to determine the affected resources. The CRA algorithm determines the number of affected resources in the host system. The device criticality report obtained from the CRA algorithm may be stored with the local IAA or sent directly to the central agent. The CRA algorithm may traverse the component hierarchy graph stored with IAA on the host system to determine the affected resources.

According to an embodiment the resource analysis may be carried out by traversing the CHG of the host system. FIG. 6 is a flow chart depicting the CHG traversal algorithm to determine the impacted nodes using the redundancy attributes associated with the nodes of CHG. The resource criticality may be obtained by checking the uses attribute and criticality attributes associated with the nodes marked as impacted.

Continuing to step 408, the list of affected resources is obtained from the CRA algorithm. The list of affected resources may be made available to the central agent by IAA on the host system. The central agent may aggregate the lists from the IAA and build a consolidated list inclusive of all the affected resources across the data center. The aggregation may be simply the union of lists from each of the IAA across the data center. The aggregated list may be presented to the user for their reference.

Example pseudo code for the algorithm for determining the device criticality during SAN reconfigurations is as follows:

```
algorithm SAN_impact( input SAN Graph,
      input Component Hierarchy of all hosts,
      input components added/removed in SAN,
      output Impacts at data center level)
begin
  Compute the reachable LUN sets {R1} for each host in the SAN graph;
  Apply the impacts of SAN reconfiguration on the nodes/edges of SAN
graph;
  Recompute the reachable LUN sets {R2} for each host in the SAN
graph;
  hosts_impacted = false;
  for each host hᵢ in the SAN do
    Compute impacted LUN set {R3} = {R1} − {R2};
    if {R3} is non-empty then
      Compute criticality of losing LUN in {R3} using CRA
on hᵢ; hosts_impacted = true;
    endif
  endfor
  if hosts_impacted then
    Report Criticality of the operation recorded and return for
      future processing;
  endif
end.
```

Additionally, the device criticality report may provide an overall result of the analysis and reason for the overall result. In this embodiment, the overall result is either success, warning, data critical, or system critical.

If the overall result is success, this indicates that the technique found no affected resources, wherein the user is provided a success message and allowed to proceed with the reconfiguration operation.

Furthermore, if the overall result is warning, this indicates that the technique found one or more affected resources. However, these affected resources were assigned the low severity level (or warning level) but none were assigned the medium severity level (or data critical level) or the high severity level (or system critical level). The user is provided a warning message stating that the affected resources are not deemed critical to system operation and allowed to proceed to the reconfiguration operation.

Continuing, if the overall result is data critical, this indicates that the technique found one or more affected resources. However, at least one of these affected resources was assigned the medium severity level (or data critical level) but none were assigned the high severity level (or system critical level). The user is provided a data critical message stating that probably or possibly data stored in the system will be lost but probably the system will not crash or enter an unhealthy/failed state. Furthermore, the report may list or enumerate all the processes in the data center that may be impacted because of the reconfiguration. The process level impacts, in turn may be mapped to a larger application level impact.

If the overall result is system critical, this indicates that the technique found one or more affected resources. However, at least one of these affected resources was assigned the high severity level (or system critical level). The user is provided a system critical message stating that the system may crash or enter an unhealthy/failed state. In this case, the user will be prevented from proceeding with the reconfiguration operation.

Any of the foregoing variations of the present technique may be implemented by programming a suitable general-purpose computer. The programming may be accomplished through the use of a program storage device readable by the computer and encoding a program of instructions executable by the computer for performing the operations described above.

The flow charts included herein do not necessarily represent an execution in a single hot plugging event, but rather, in some instances, may represent a sequence of coordinated steps, events, or processes occurring in plurality of hot plugging operations. In addition, the flow charts herein should not be interpreted as implying that no other events, steps, or processes can occur between those explicitly represented in the drawings.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method for determining device criticality for reconfiguration of a storage area network comprising the steps of:
building a storage area network connectivity graph;
identifying the host systems affected by a reconfiguration operation from storage area network connectivity graph; and
evoking a critical resource analysis algorithm for each affected host system to determine the affected resources on the affected host systems.

2. A method as recited in claim 1, wherein a host system is determined as affected if the set of reachable LUNs is not the same before and after mapping of a reconfiguration operation onto the storage area network connectivity graph.

3. A method as recited in claim 1 further comprising: accumulating device criticality data generated by the critical resource analysis in each from affected host systems and generating a device criticality report for a data center administrator.

4. A method as recited in claim 1 wherein the critical resource analysis is carried out by an impact analysis agent deployed on each of the host systems of the data center.

5. A method as recited in claim 3 wherein the accumulating step is carried out by a central agent for aggregating the results from impact analysis agents and providing a consolidated report to data center administrator.

6. A method as recited in claim 1 further comprising building a component hierarchy graph for each of the host system of data center.

7. A method as recited in claim 6 wherein the component hierarchy graph is a directed acyclic graph.

8. A method as recited in claim 6 further comprising storing usage attributes, redundancy attributes and/or criticality attributes in the component hierarchy graph.

9. A method as recited in claim 1 further comprising traversing the component hierarchy graph of host systems for determining affected resources.

10. A method as recited in claim 1 further comprising classifying the result of device criticality as success, warning, data critical, system critical, or error.

11. A method as recited in claim 1 further comprising a graphical user interface for presenting the state of the SAN to a user and for recommending actions to the user.

12. Apparatus for determining device criticality for a reconfiguration operation of a storage area network comprising:
a central agent for locating the host systems affected by a reconfiguration operation from a storage area network connectivity graph; and
an impact analysis agent for evoking a critical resource analysis algorithm for each affected host system to determine the affected resources on the affected host systems.

13. Apparatus as recited in claim 12 wherein the central agent further comprises a SAN graph generation unit for generating the storage area network connectivity graph.

14. Apparatus as recited in claim 12, wherein the impact analysis agent is arranged to generate the component hierarchy graph for a host system.

15. Apparatus as recited in claim 12 wherein a host system is determined as affected if the set of reachable LUNs is not the same before and after mapping of a reconfiguration operation onto the storage area network connectivity graph

16. An impact analysis agent as recited in claim 14, further comprising an storage element for storing the list of affected resources generated by the critical resource algorithm.

17. A central agent as recited in claim 12 further comprising accumulating the device criticality data from impact analysis agents and generating a device criticality report for data center administrator.

18. Apparatus according to claim 10 comprising a graphical user interface for presenting the state of the SAN to a user and for recommending actions to the user.

19. A computer program product for execution by a server computer for determining device criticality for reconfiguration of a storage area network comprising the steps of:
building a storage area network connectivity graph;
identifying the host systems affected by a reconfiguration operation from storage area network connectivity graph; and
evoking a critical resource analysis algorithm for each affected host system to determine the affected resources on the affected host systems.

20. A computer program product as recited in claim 19, wherein a host system is determined as affected if the set of reachable LUNs is not the same before and after mapping of a reconfiguration operation onto the storage area network connectivity graph.
